(19) United States
(12) Patent Application Publication
(10) Pub. No.: US 2016/0119811 A1
(43) Pub. Date: Apr. 28, 2016

(54) A-MPDU IN THE LEGACY PHYSICAL LAYER

(71) Applicant: QUALCOMM Incorporated, San Diego, CA (US)

(72) Inventors: Simone MERLIN, Solana Beach, CA (US); Maarten Menzo WENTINK, Naarden (NL)

(21) Appl. No.: 14/924,398

(22) Filed: Oct. 27, 2015

Related U.S. Application Data
(60) Provisional application No. 62/069,735, filed on Oct. 28, 2014.

(51) Int. Cl. H04W 28/02; H04L 5/00; H04W 74/00

(52) U.S. Cl. CPC H04W 28/0231; H04W 74/006; H04L 5/0055; H04W 84/12

(57) ABSTRACT

A method, an apparatus, and a computer-readable medium for wireless communication are provided. In one aspect, an apparatus is configured generate a frame that includes a preamble decodable by a first device type and by a second device type and a plurality of data units. The preamble includes a plurality of fields and each field of the plurality of fields is decodable by the first device type. Each data unit of the plurality of data units includes a payload and an error detection field decodable by the second device type. The apparatus is further configured to transmit the frame to a second wireless device.

### CROSS-REFERENCE TO RELATED APPLICATION(S)

This application claims the benefit of U.S. Provisional Application Ser. No. 62/069,735, entitled “A-MPDU in the Legacy Physical Layer” and filed on Oct. 28, 2014, which is expressly incorporated by reference herein in its entirety.

### BACKGROUND

1. Field

The present disclosure relates generally to communication systems, and more particularly, to utilizing an aggregated medium access control (MAC) protocol data unit (A-MPDU) in a legacy physical layer.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable medium, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides a wireless device (e.g., an access point or a station) for wireless communication. The wireless device is configured to generate a frame that includes a preamble decodable by a first device type and by a second device type and a plurality of data units. The preamble includes a plurality of fields and each field of the plurality of fields is decodable by the first device type. Each data unit of the plurality of data units includes a payload and an error detection field decodable by the second device type. The wireless device is further configured to transmit the frame to a second wireless device.

### BRIEF DESCRIPTION OF THE DRAWINGS

FIG. 1 shows an example wireless communication system in which aspects of the present disclosure may be employed.

FIG. 2 is a diagram of a wireless network.

FIG. 3 is an exemplary diagram of a first frame type decodable by legacy and non-legacy wireless devices (e.g., STAs, APs).

FIG. 4 is an exemplary diagram of a second frame type decodable by legacy and non-legacy wireless devices (e.g., STAs, APs).

FIG. 5 is an exemplary diagram of a third frame type decodable by legacy and non-legacy wireless devices (e.g., STAs, APs).

FIG. 6 is an exemplary diagram of a fourth frame type decodable by non-legacy wireless devices (e.g., STAs, APs).

FIG. 7 is a functional block diagram of a wireless device that may be employed within the wireless communication system of FIG. 1 and may utilize one of the frame types described in FIGS. 3-6.

FIG. 8 is a flowchart of an exemplary method of wireless communication using a modified frame type.

FIG. 9 is a functional block diagram of an exemplary wireless communication device using a modified frame type.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams (or multi-streams), and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

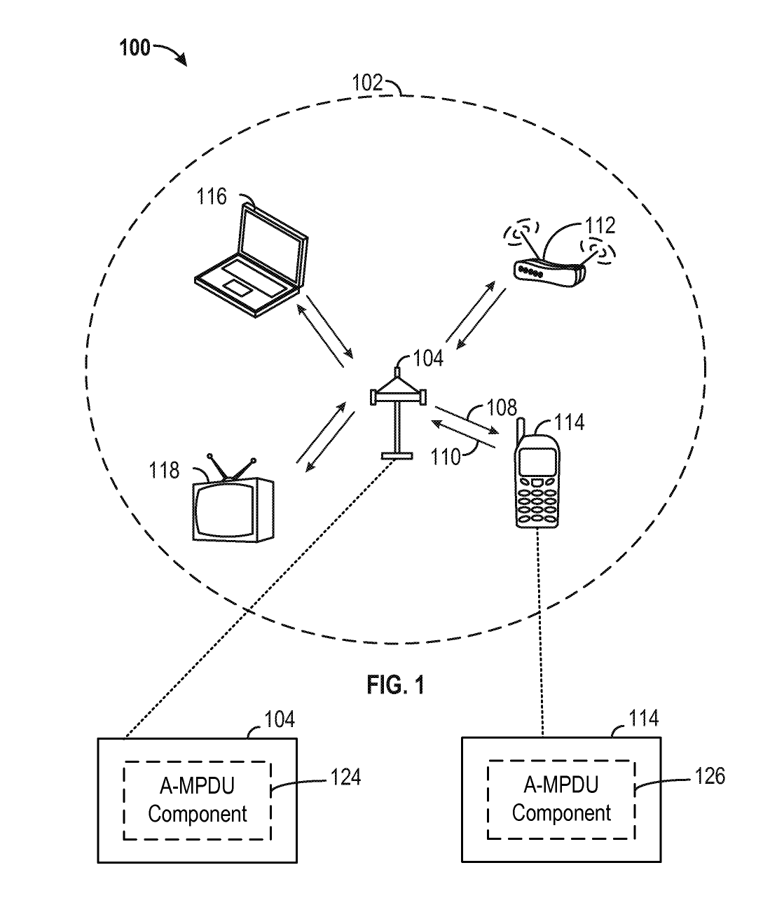

FIG. 1 shows an example wireless communication system 100 in which aspects of the present disclosure may be employed. The wireless communication system 100 may operate pursuant to a wireless standard, for example current or future 802.11 standards. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include an A-MPDU component 124 configured to generate a frame that may include a preamble decodable by a first device type and by a second device type and a number of data units. The preamble may include a number of fields, and each field in the number of fields may be decodable by the first device type. Each data unit of the number of data units may include a payload and an error detection field addressed to (or decodable by or intended for) the second device type. The A-MPDU component 124 may be configured to transmit the frame to a second wireless device.

In another aspect, the STA 114 may include one or more components for performing various functions. For example, the STA 114 may include an A-MPDU component 126 configured to generate a frame that may include a preamble decodable by a first device type and by a second device type and a number of data units. The preamble may include a number of fields, and each field in the number of fields may be decodable by the first device type. Each data unit of the number of data units may include a payload and an error detection field addressed to (or decodable by or intended for) the second device type. The A-MPDU component 126 may be configured to transmit the frame to a second wireless device.

Certain Wi-Fi standards/specifications (e.g., IEEE 802.11ac, IEEE 802.11n) limit the use of aggregated MPDU with High Throughput (HT), Very High Throughput (VHT), or directional multi-gigabit (DMG) physical (PHY) (DMG PHY) specification formats. For example, in a DMG physical layer convergence procedure (PLCP) protocol data unit (PPDU), which may be utilized in IEEE 802.11ac products, an A-MPDU is a sequence (or concatenation) of MPDUs carried in a single PPDU with the TXVECTOR/RXVECTOR AGGREGATION parameter set to 1. In non-DMG PPDUs, an A-MPDU is a sequence of A-MPDU subframes carried in a single PPDU with one of the following combinations of RXVECTOR or TXVECTOR parameter values: the FORMAT parameter set to VHT; or the FORMAT parameter set to HT_MF or HT_GF and the AGGREGATION parameter set to 1. While A-MPDUs may be used in products compliant with the IEEE 802.11ac/n standards, A-MPDUs cannot be carried in packets conforming to certain legacy PHY standards, such as the IEEE 802.11a/g/b standards. It is desirable to send A-MPDUs in IEEE 802.11a/g packets due to such packets having a short preamble and legacy decodability. It may also be desirable to send A-MPDUs in IEEE 802.11b packets because such packets may have a larger range than other PHY modes. IEEE 802.11b packets may have a longer PHY preamble, which may be amortized with A-MPDU aggregation.

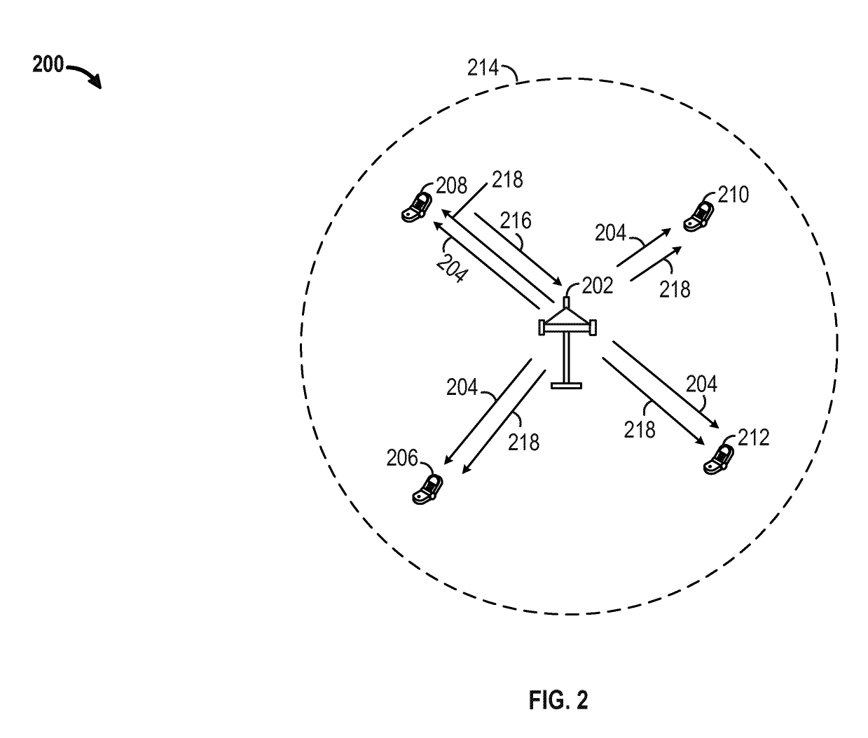

FIG. 2 is a diagram 200 of a wireless network (e.g., a Wi-Fi network). The diagram 200 illustrates an AP 202 broadcasting/transmitting within a service area 214. STAs 206, 208, 210, 212 are within the service area 214 of the AP 202 (although only 4 STAs are shown in FIG. 2, more or less STAs may be within the service area 214).

The AP 202 may transmit a frame 204 to one or more STAs (e.g., STAs 206, 208, 210, 212) and vice versa. A frame may include a preamble and data symbols. The preamble may be considered a header of the frame with information identifying a modulation scheme, a transmission rate, and a length of time to transmit the frame. The preamble may include a signal (SIG) field, a short training field (STF), and one or more long training field (LTF) symbols. The SIG field may be used to transfer rate and length information. The STF may be used to improve automatic gain control (AGC) in a multi-transmit and multi-receive system. The LTF symbols may be used to provide information that enables a receiver (e.g., the STA 206) to perform channel estimation. The number of LTF symbols in the preamble may be equal to or greater than the number of space-time streams from different STAs. For example, if there are 4 STAs, there may be 4 LTF symbols within the preamble. The data symbols may contain the user data to be communicated between the STA 206, for example, and the AP 202. The preamble may be followed by a set of service bits (e.g., 16 bits).

In an aspect, referring to FIG. 2, the STAs 206, 208, 210, 212 may be different types of wireless products that conform to different wireless standards. For example, the STA 208 may conform to a future IEEE 802.11 standard (e.g., an IEEE 802.11ax standard), the STA 212 may conform to the IEEE 802.11ac/n standards, the STA 206 may conform to the IEEE 802.11a/b standards, and the STA 210 may conform to IEEE 802.11a/g standards. In this aspect, the AP 202 may desire to transmit a frame 204 containing an A-MPDU to the STA 208 in a broadcast transmission. The frame 204 may conform to the IEEE 802.11ac/n standards. When the STAs 208, 212 receive the frame 204, the STAs 208, 212 may be able to decode the frame 204 because the STAs 208, 212 are compatible with the IEEE 802.11ac/n standards and may decode a frame with an A-MPDU. Upon receiving the frame 204, the STA 212 may set or update a network allocation vector (NAV) based on a duration field in the frame 204 which may indicate the duration of the transmission with respect to the frame 204. The NAV is a carrier-sensing mechanism, which may be a counter or a timer that indicates the amount of time that may elapse before the STA 212 is allowed to check the channel/medium for idleness or to access the medium/channel. The NAV effectively reserves a channel for use by the STA 208 until a period of time has elapsed. In one configuration, the STAs 206, 210 may not be able to decode the frame 204 with an A-MPDU because the STAs 206, 210 are compatible only with legacy Wi-Fi standards such as IEEE 802.11a/b/g. If legacy devices, like the STAs 206, 210, transmit concurrently with non-legacy devices, increased traffic and interference over the wireless medium may result. As such, a need exists for a frame that is modified to enable the STAs 206, 210 to decode the frame in order to set the NAV.

For example, in one configuration, the AP 202 may generate a second frame 218 that includes a preamble decodable by a legacy device type (e.g., an IEEE 802.11a/b/g product) and by a non-legacy device type (e.g., an IEEE 802.11ac/n product or a product that complies with future Wi-Fi standards). The preamble may include a number of fields, and each field may be decodable by a legacy device type. The second frame 218 may include a number of data units (e.g., MPDUs), and each data unit may include a payload and an error detection field addressed to (or decodable by) the non-legacy device type. The STA 208 may receive the second frame 218 and transmit a block acknowledgment message 216 to the AP 202. The block acknowledgment message 216 may include a sequence number and a bitmap. The sequence number in the block acknowledgment message 216 may be associated with a sequence number of the second frame 218 (e.g., or a different frame), and the bitmap may include a number of bits, and each bit in the number of bits may be associated with a data unit in the second frame 218 and indicate whether each data unit in the second frame 218 was correctly received.

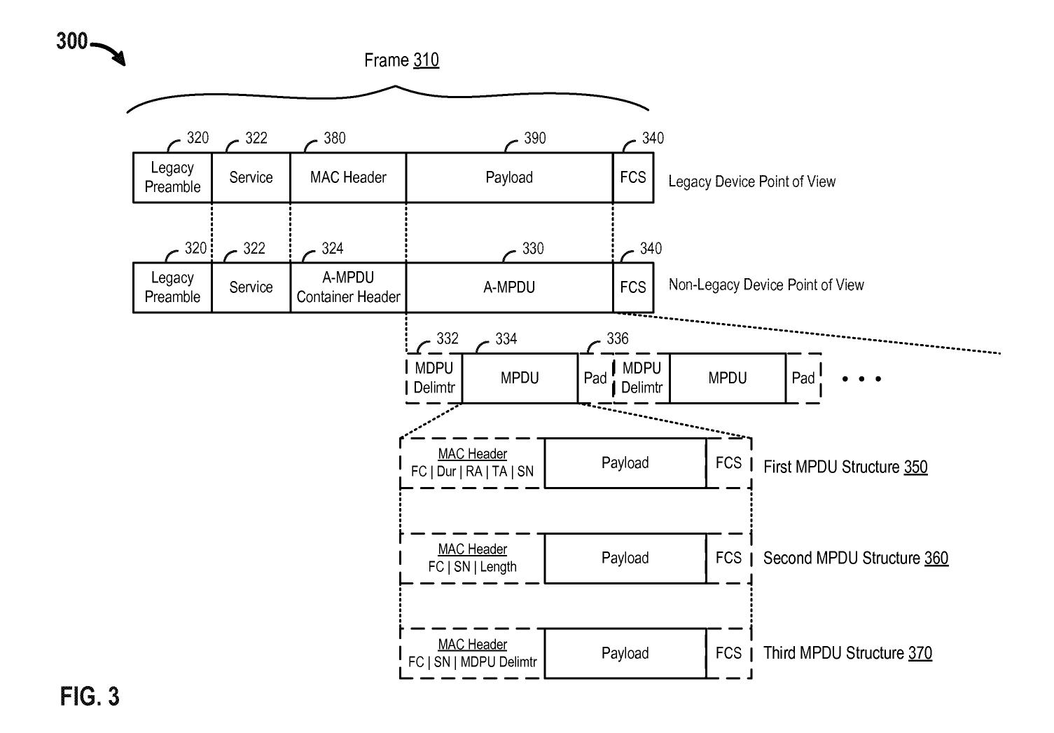

The STA 212 may also receive the second frame 218 and determine that the second frame is intended for the STA 208. The STA 212 may set the NAV based on the second frame 218. The STAs 206, 210 may also receive the second frame 218. Because the second frame 218 includes a preamble decodable by legacy devices, the STAs 206, 210 may be able to set the NAV based on information (e.g., a time duration associated with the second frame 218) contained in the second frame 218. As discussed with respect to FIGS. 3-6, different frame structures or frame types may be used to implement the second frame 218.

FIG. 3 is an exemplary diagram 300 of a first frame type decodable by legacy and non-legacy wireless devices (e.g., STAs, APs). Referring to FIG. 3, a frame 310 may include a legacy preamble 320, a set of service bits 322, an A-MPDU container header 324, an A-MPDU 330, and a frame check sequence (FCS) 340. In an aspect, the legacy preamble 320 may include a number of fields and each field may be compliant with at least one of the IEEE 802.11a/b/g standards (e.g., the frame 310 may not include a non-legacy preamble compliant with (or only compliant with) the IEEE 802.11ac/n standard or future standards). The legacy preamble 320 may be a preamble that is compatible with the IEEE 802.11a/b/g standards and may indicate a time duration of the frame 310. The set of service bits 322 may be a set of 16 bits used for control information (e.g., scrambler information). The A-MPDU container header 324 may indicate that the A-MPDU 330 is present in the frame 310 and/or may indicate a type or sub-type of the A-MPDU 330. The A-MPDU container header 324 may also indicate a time duration of the A-MPDU 330. The A-MPDU 330 may include a plurality of aggregated MPDUs 334. In the A-MPDU 330, each MPDU 334 may be preceded by an MPDU delimiter 332 and, unless the MPDU 334 is a last MPDU in the A-MPDU 330, may be followed by a set of padding bits 336. The MPDU delimiter 332 may indicate the start/beginning of a new MPDU. The MPDU delimiter 332 may be 32 bits in length and include an end-of-frame (EOF) field, a 3-bit reserved field, a 12-bit MPDU length field, an 8-bit CRC field, and/or an 8-bit signature field. The 12-bit MPDU length field may be used by a receiver to parse the A-MPDU 330 and extract the following MPDU 334. As shown in FIG. 3, the MPDU 334 includes an MPDU header (e.g., MAC header), a payload, and an MPDU FCS.

By inserting the legacy preamble 320 and the A-MPDU container header 324 into the frame 310, legacy STAs (e.g., the STAs 206, 210) may be able to decode/parse some (or all) of the legacy preamble 320 and the A-MPDU container header 324 in the frame 310 and compute the FCS 340, which may be a CRC. In an aspect, the FCS 340 may be computed based on the frame 310. In another aspect, the FCS 340 may be computed based on the A-MPDU 330. The legacy STAs may not be able to decode the A-MPDU 330, but that is not a problem because the legacy STAs may not be the intended recipient of the A-MPDU 330. Nevertheless, by being able to decode/parse the legacy preamble 320 of the frame 310 and determine the time duration of the frame 310 based on information contained in the A-MPDU container header 324, the legacy STAs may be able to set the NAV. A non-legacy STA (e.g., the STAs 208, 212) may be able to decode the legacy preamble 320. The non-legacy STA may also be able to decode the A-MPDU container header 324 and determine that the A-MPDU 330 is present in the frame 310. If the non-legacy STA is the intended recipient (e.g., the STA 208) of the frame 310, the non-legacy STA may then decode the data within the A-MPDU 330. If the non-legacy STA is not the intended recipient (e.g., the STA 212) of the frame 310, the non-legacy STA may set the NAV based on the time duration information in the frame 310.

As such, upon receiving the frame 310, the legacy STA may view the frame from the legacy device point of view. That is, the frame 310 may include the legacy preamble, the set of service bits 322, a MAC header 380, a payload 390, and the FCS 340. In other words, the legacy STA may view the MAC header 380, the payload 390, and the FCS 340 as a single MPDU. By contrast, a non-legacy STA may be able to discern that the MAC header 380 is the A-MPDU container header 324 associated with the A-MPDU 330, and the payload 390 is the A-MPDU 330. Also, in the frame 310, the legacy preamble 320 may not indicate the presence of the A-MPDU 330. Instead, the presence of the A-MPDU 330 may be indicated in fields outside of the legacy preamble 320, such as in the A-MPDU container header 324. In an aspect, the A-MPDU container header 324 and the A-MPDU 330 may not be separated by either tail bits or pad bits.

The MPDUs 334 in the A-MPDU 330 may utilize various structures. Referring to FIG. 3, in a first MPDU structure 350, the MPDU 334 may include an MPDU (or MAC) header, a payload, and an MPDU FCS. The MPDU header in the first MPDU structure 350 may include a frame control (FC) field, a duration field, a receive address, a transmit address, and a sequence number. The duration field may indicate a time duration of the MPDU 334. The receive address may correspond to the MAC address of the intended recipient of the MPDU 334. The transmit address may correspond to the MAC address of the transmitter or source of the MPDU 334. For all MPDUs within the A-MPDU 330, the duration field, the receive address, and transmit address may be identical. Because each MPDU 334 with the first MPDU structure 350 has the same duration field, receive address field, and transmit address field, there is a lot of redundancy within the A-MPDU 330. As such, the structure of the A-MPDU 330 may be compressed by including information common across all MPDUs in the A-MPDU container header 324.

For example, in another configuration, the A-MPDU container header 324 may indicate a presence of the A-MPDU 330 (and/or a type or subtype of the A-MPDU 330) and may include the duration field, receive address, and transmit address associated with and common to all of the MPDUs 334. In an aspect, if the frame 310 is transmitted in an uplink, the receive address in the A-MPDU container header 324 may be broadcast or multicast. In this configuration, each MPDU 334 may be associated with a second MPDU structure 360. Each MPDU 334 having the second MPDU structure 360 may include an FC field, a sequence number, and a length field. The length field in the second MPDU structure 360 indicates the length of the MPDU 334. In the second MPDU structure 360, the MPDU header does not include a duration field, a receive address, or a transmit address because this information has been placed into the A-MPDU container header 324. By reducing some redundant information, the structure of the A-MPDU 330 may be compressed.

In another configuration, the A-MPDU container header 324 may indicate a presence of the A-MPDU 330 and/or a type or subtype of the A-MPDU 330 and may include the duration field, receive address, and transmit address associated with and common to all of the MPDUs 334. In an aspect, if the frame 310 is transmitted in an uplink, the receive address in the A-MPDU container header 324 may be broadcast or multicast. In this configuration, each MPDU 334 may be associated with a third MPDU structure 370. Each MPDU 334 having the third MPDU structure 370 may include an FC field, a sequence number, and an MPDU delimiter. The MPDU delimiter may indicate the start and/or presence of an MPDU. The MPDU delimiter may follow the FC field and the sequence number but precede the payload and the MPDU FCS. In an aspect, because an MPDU delimiter is already present in the MPDU header in the third MPDU structure 370, each MPDU 334 in the A-MPDU 330 may not be preceded by the MPDU delimiter 332. In another aspect, each MPDU 334 in the A-MPDU 330 may be preceded by the MPDU delimiter 332, and the MPDU header associated with the third MPDU structure 370 also contains an MPDU delimiter. In the third MPDU structure 370, the MPDU header does not include a duration field, a receive address, or a transmit address because this information has been placed into the A-MPDU container header 324. By reducing some redundant information, the structure of the A-MPDU 330 may be compressed.

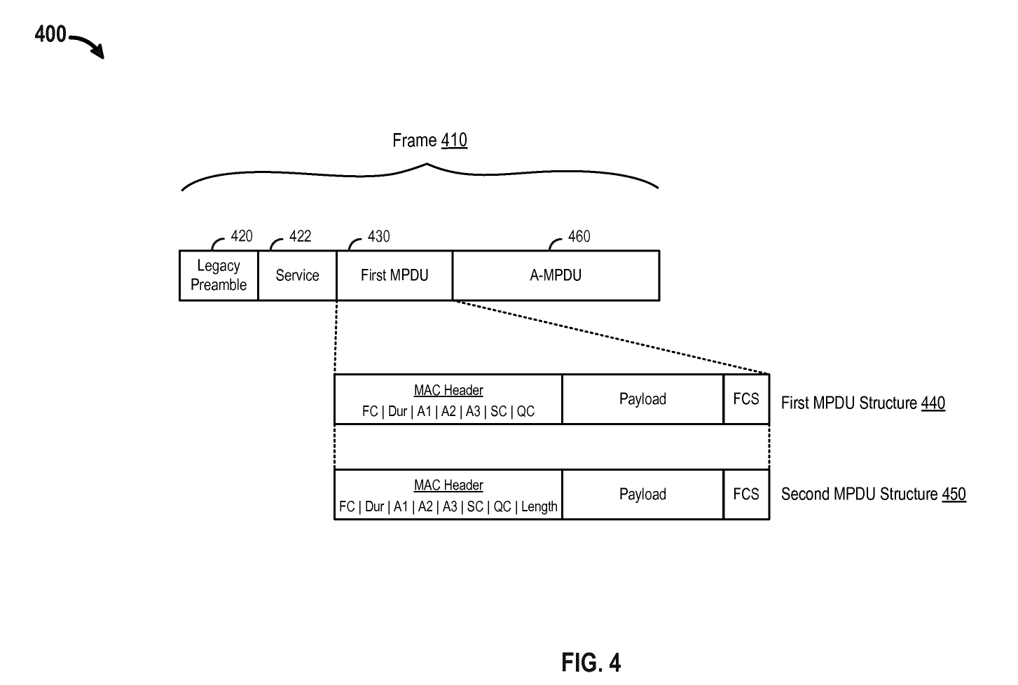

FIG. 4 is an exemplary diagram 400 of a second frame type decodable by legacy and non-legacy wireless devices (e.g., STAs, APs). Referring to FIG. 4, a frame 410 may include a legacy preamble 420, a set of service bits 422, a first MPDU 430, and an A-MPDU 460. The legacy preamble 420 may be a preamble that is compatible with the IEEE 802.11a/b/g standards. In an aspect, the legacy preamble 420 may include a number of fields and each field may be compliant with at least one of the IEEE 802.11a/b/g standards (e.g., the frame 410 may not include a non-legacy preamble compliant with IEEE 802.11ac/n or future standards). The set of service bits 422 may be a set of 16 bits used for control information. The first MPDU 430 may not include an MPDU delimiter, and the first MPDU 430 may be decodable by products compliant with legacy Wi-Fi standards (e.g., IEEE 802.11/a/b/g) and compliant with non-legacy Wi-Fi standards (e.g., IEEE 802.11ac/n or future standards assuming backwards compatibility). The first MPDU 430 may be associated with one of two structures—a first MPDU structure 440 or a second MPDU structure 450. In the first MPDU structure 440, the first MPDU 430 includes an MPDU (or MAC) header, a payload, and an MPDU FCS. The MPDU header includes an FC field, a duration field, 3 address fields, a sequence control field, and a quality of service (QoS) control field. The 3 address fields may include a receive address, transmit address, and destination address, respectively. In the second MPDU structure 450, the first MPDU 430 includes an MPDU header, a payload, and an FCS. The MPDU header includes an FC field, a duration field, 3 address fields, a sequence control field, a QoS control field, and a length field. The length may indicate the length of the first MPDU 430.

After the first MPDU 430, an A-MPDU 460 may be included in the frame 410. The A-MPDU 460 may include one or more MPDUs aggregated together. Each MPDU in the A-MPDU 460 may have a structure similar to the first MPDU structure 350 in FIG. 3 or to the first MPDU structure 440. Additionally, each MPDU in the A-MPDU 460 may be preceded by an MPDU delimiter, such as the MPDU delimiter 332 in FIG. 3 and may be followed by a set of padding bits such as the set of padding bits 336 in FIG. 3. However, an FCS field in a last MPDU in the A-MPDU 460 may be computed for the A-MPDU 460 and the first MPDU 430. When a non-legacy STA (e.g., IEEE 802.11ac/n product or a product compliant with future IEEE 802.11 standards, such as the STA 208) receives the frame 410, the non-legacy STA may decode the first MPDU 430 and search for the A-MPDU 460. In one aspect, if the first MPDU 430 has the first MPDU structure 440, the non-legacy STA may find the A-MPDU 460 by detecting an MPDU delimiter that precedes each MPDU in the A-MPDU 460. In another aspect, the non-legacy STA may determine that the A-MPDU 460 exists because the time duration of the frame 410 may be significantly longer than the time duration contained in the duration field of the MPDU header of the first MPDU 430. In another aspect, if the first MPDU 430 has the second MPDU structure 450, the non-legacy STA may determine the length of the first MPDU 430 based on the length field in the MPDU header. The non-legacy STA may determine that the A-MPDU 460 exists in one of the following ways: i) the number of bytes contained in the payload (which may be computed from the MCS and length field in the legacy preamble) is not compatible with a legacy transmission ii) the non-legacy STA may scan for the A-MPDU delimiter signature and CRC. In another aspect, the set of service bits 422 and/or the MDPU header of the first MPDU 430 may have one or more bits indicating that the A-MPDU 460 is present.

When a legacy STA (e.g., IEEE 802.11/a/b/g product, such as the STAs 206, 210) receives the frame 410, the legacy STA may decode the first MPDU 430. The legacy STA may set the NAV based on the duration field in the MPDU header of the first MPDU 430. As previously discussed the A-MPDU 460 includes a number of aggregated MPDUs, and each MPDU includes an MPDU/MAC header, payload, and FCS. In one aspect, if the FCS for the last MPDU in the A-MPDU 460 is computed for the last MPDU, then the legacy STA may fail in decoding the frame 410 and not set the NAV. In another aspect, if the FCS of the last MPDU of the A-MPDU 460 is computed based on the entire payload (e.g., the first MPDU 430 and the A-MPDU 460), the legacy STA may successfully decode the frame 410 and set the NAV based on the time duration indicated in the first MPDU 430.

In an aspect, in the frame 410, the legacy preamble 420 may not indicate the presence of the A-MPDU 460. Instead, the presence of the A-MPDU 460 may be indicated in fields outside of the legacy preamble 420, such as through MPDU delimiters in the A-MPDU 460. In another aspect, the first MPDU 430 and the A-MPDU 460 may not be separated by either tail bits or pad bits.

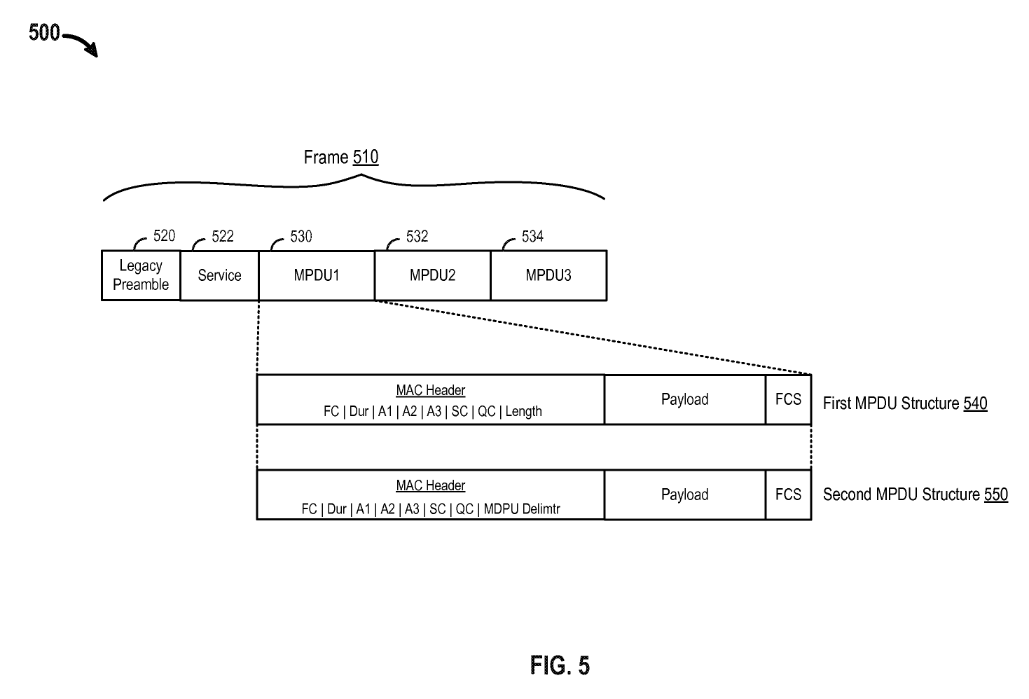

FIG. 5 is an exemplary diagram 500 of a third frame type decodable by legacy and non-legacy wireless devices (e.g., STAs, APs). Referring to FIG. 5, a frame 510 may include a legacy preamble 520, a set of service bits 522, and one or more MPDUs (e.g., a first MPDU 530, a second MPDU 532, a third MPDU 534, etc.). Unlike in FIGS. 3 and 4, the frame 510 may not contain an A-MPDU. The legacy preamble 520 may be a preamble that is compatible with the IEEE 802.11a/b/g standards. In an aspect, the legacy preamble 520 may include a number of fields and each field may be compliant with at least one of the IEEE 802.11a/b/g standards (e.g., the frame 510 may not include a non-legacy preamble compliant only with IEEE 802.11ac/n or future standards). The set of service bits 522 may be a set of 16 bits used for control information.

The first MPDU 530 may be decodable by products compliant with legacy Wi-Fi standards (e.g., IEEE 802.11/a/b/g such as the STAs 206, 210) and non-legacy Wi-Fi standards (e.g., IEEE 802.11ac/n such as the STAs 208, 212). The MPDUs 530, 532, 534 may be associated with one of two structures—a first MPDU structure 540 or a second MPDU structure 550.

In one configuration, under the first MPDU structure 540, the first MPDU 530 (and other MPDUs in the frame 510) may include an MPDU (or MAC) header, a payload, and an FCS. The MPDU header may include an FC field, a duration field, 3 address fields, a sequence control field, a QoS control field, and a length field. The 3 address fields may include a receive address, transmit address, and destination address, respectively. The length field may indicate the length of the MPDU (e.g., the first MPDU 530). By incorporating a length field into the MPDU header, the first MPDU 530 (and subsequent MPDUs in the frame 510) having the first MPDU structure 540 may not be preceded by an MPDU delimiter. In an aspect, a last MPDU of the MPDUs included in the frame 510 may include an MPDU header, payload, and FCS. The FCS in the last MPDU may be computed based on all the MPDUs included in the frame 510. In one example, when a legacy STA (e.g., the STA 206) receives the frame 510, the legacy STA may be able to successfully decode the legacy preamble 520 and the duration field of the MDPU header in the first MPDU 530 and set the NAV based on the duration field. When a non-legacy STA (e.g., the STA 208) receives the frame 510, the non-legacy STA may be able be able to decode/parse each MPDU in the set of MPDUs included in the frame 510 based on the length of each MPDU in the set of MPDUs.

In another configuration, under the second MPDU structure 550, the first MPDU 530 (and other MPDUs in the frame 510) may include an MPDU (or MAC) header, a payload, and an FCS. The MPDU header may include an FC field, a duration field, 3 address fields, a sequence control field, a QoS control field, and an MPDU delimiter (e.g., the MPDU delimiter 332). In aspect, instead of placing an MPDU delimiter before each MPDU, the MPDU delimiter may be placed within the MDPU header of each MPDU. In an aspect, a last MPDU of the MPDUs included in the frame 510 may include an MPDU header, payload, and FCS. The FCS of the last MPDU may be computed based on all the MPDUs included in the frame 510. In one example, when a legacy STA (e.g., the STA 206) receives the frame 510, the legacy STA may be able to successfully decode the legacy preamble 520 and the duration field of the MPDU header of the first MPDU 530 and set the NAV based on the duration field. When a non-legacy STA (e.g., the STA 208) receives the frame 510, the non-legacy STA may be able be able to parse and decode each MPDU in the set of MPDUs included in the frame 510 by detecting the MPDU delimiter.

In an aspect, in the frame 510, the legacy preamble 520 may not indicate the presence of the multiples MPDUs. Instead, the presence of the MPDUs may be indicated in fields outside of the legacy preamble 5, such as through each MAC header of the MPDUs (e.g., length field, MPDU delimiter). In another aspect, the MPDU 530 and the MPDU 532 may not be separated by either tail bits or pad bits.

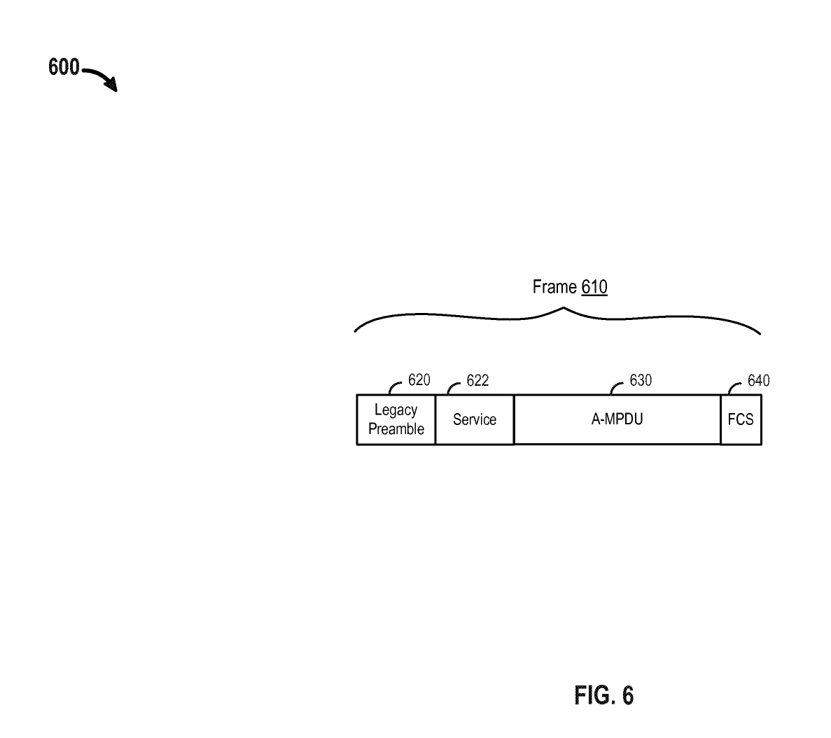

FIG. 6 is an exemplary diagram 600 of a fourth frame type decodable by non-legacy wireless devices (e.g., STAs, APs). Referring to FIG. 6, a frame 610 may include a legacy preamble 620, a set of service bits 622, an A-MPDU 630, and an FCS 640. The legacy preamble 620 may be a preamble that is compatible with the IEEE 802.11a/b/g standards. In an aspect, the legacy preamble 320 may include a number of fields and each field may be compliant with at least one of the IEEE 802.11a/b/g standards (e.g., the frame 610 may not include a non-legacy preamble compliant only with IEEE 802.11ac/n). The set of service bits 622 may be a set of 16 bits used for control information. The A-MPDU 630 may include a number of MPDUs aggregated together. The A-MPDU 630 may have a similar structure to the A-MPDU 330 in FIG. 3, in which each MPDU in the A-MPDU 630 is preceded by an MPDU delimiter and followed by a set of padding bits.

In an aspect, non-legacy STAs (e.g., the STA 208) may determine that the A-MPDU 630 is an A-MPDU by detecting an MDPU delimiter. In another aspect, if no MPDU delimiter is detected by the non-legacy STA, the non-legacy STA may determine that there is no A-MPDU in the frame 610. In another aspect, the presence or absence of an A-MPDU may be indicated in either a SIG field (using reserved bits) of the legacy preamble 620 and/or the service bits 622 (which may have 2 bytes, some of which may be reserved bits that may be used for signaling the presence of an A-MPDU). In this aspect, legacy STAs (e.g., the STA 206) may not be able to decode the A-MPDU 630 and therefore may not set the NAV.

In FIGS. 3-6, reception of an A-MPDU (e.g., the A-MPDU 330, the A-MPDU 460, or the A-MPDU 630) or a number of MPDUs may be indicated by a block acknowledgment. The block acknowledgment may include a sequence number associated with a MPDU or A-MPDU within a particular frame. The block acknowledgment may also include a bitmap with a set of bits corresponding to one or more corresponding MPDUs in the frame or A-MPDU. A bit within the set of bits may be set to 1 if an MPDU is successfully decoded or set to 0 if an MPDU is unsuccessfully decoded.

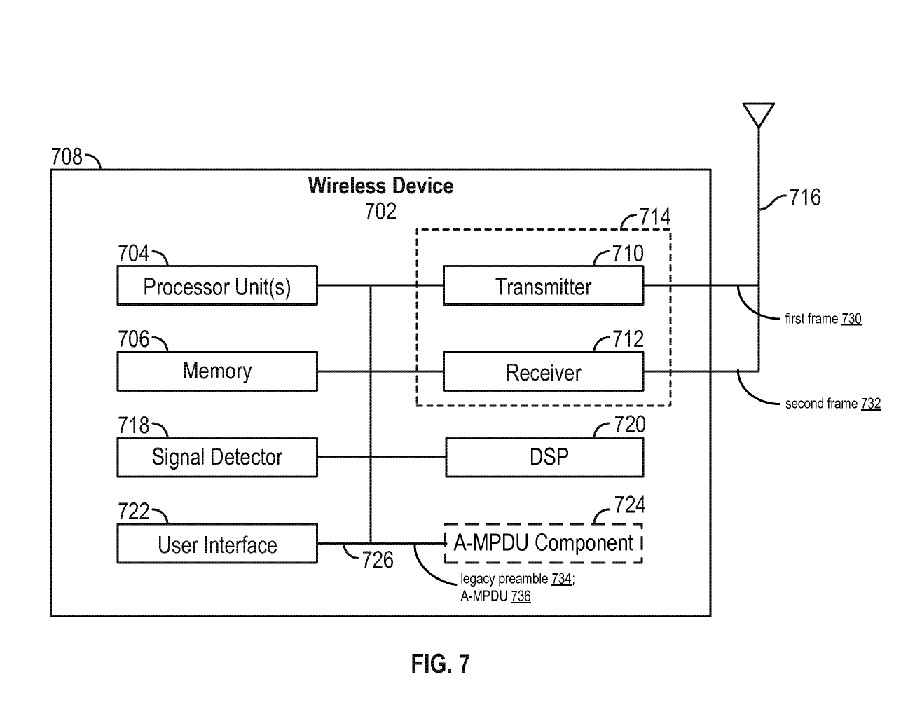

FIG. 7 is a functional block diagram of a wireless device 702 that may be employed within the wireless communication system 100 of FIG. 1 and may utilize one of the frame types described in FIGS. 3-6. The wireless device 702 is an example of a device that may be configured to implement the various methods described herein. For example, the wireless device 702 may be the AP 104, the AP 202, the STAs 112, 114, 116, 118, or the STAs 208, 212.

The wireless device 702 may include a processor 704 which controls operation of the wireless device 702. The processor 704 may also be referred to as a central processing unit (CPU). Memory 706, which may include both read-only memory (ROM) and random access memory (RAM), may provide instructions and data to the processor 704. A portion of the memory 706 may also include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a digital signal processor (DSP) 720 for use in processing signals. The DSP 720 may be configured to generate a packet for transmission. In some aspects, the packet may comprise a PPDU.

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as an AP (e.g., AP 104, AP 202) or as a STA (e.g., the STA 114, the STA 206), the wireless device 702 may also include an A-MPDU component 724. The A-MPDU component 724 may be configured to generate a frame (e.g., a first frame 730) that includes a preamble (e.g., a legacy preamble 734) decodable by a first device type and by a second device type and a number of data units (e.g., an A-MPDU 736). The preamble may include a number of fields, and each field of the plurality of fields may be decodable by the first device type. Each data unit may include a payload and an error detection field addressed to the second device type. The A-MPDU component 724 may be configured to transmit the frame to a second wireless device. In one configuration, each data unit of the number of data units may be aggregated into an aggregated data unit. The frame may further include a container header field and a container error detection field. The container header field may include information associated with the aggregated data unit, and the container error detection field may be based on the aggregated data unit. In another configuration, the information in the container header field may include a receive address, a transmit address, and a duration value associated with each data unit of the data units, and each data unit of the data units may not include the receiver address, the transmitter address, and the duration value. In another configuration, each data unit of the number of data units may further include a length field. The length field may indicate a data length of the payload. In another configuration, each data unit of the number of data units further may include a delimiter field. In another configuration, the number of data units may include an unaggregated data unit and a subset of data units. In this configuration, each data unit in the subset of data units may be preceded by a delimiter field and each data unit in the subset of data units may be aggregated into an aggregated data unit that includes a plurality of delimiter fields. Also in this configuration, the error detection field of a last data unit in the aggregated data unit may be based on the plurality of data units. In another configuration, the unaggregated data unit may include a duration field and a length field. In this configuration, the length field may indicate a data length of the payload in the unaggregated data unit. In another configuration, each data unit of the number of data units may include a header field that includes a length field indicating a data length of the payload. In this configuration, each data unit of the number of data units may not be preceded by a delimiter field. In another configuration, each data unit of the number of data units may include a header field that includes a number/set of fields and a delimiter field. In this configuration, the set of fields may precede the delimiter field, and the delimiter field may precede the payload. In another configuration, each data unit of the number of data units may be aggregated into an aggregated data unit. In another configuration, the frame may include information associated with the aggregated data unit in at least one of a signal field included within the preamble or a service field. In another configuration, the A-MPDU component 724 may be configured to receive a second frame (e.g., a second frame 732) from the second wireless device and set a network allocation vector based on the received second frame. In another configuration, the A-MPDU component 724 may be configured to receive a second frame (e.g., the second frame 732) from the second wireless device and transmit a block acknowledgment message to the second wireless device. The block acknowledgment message may include a sequence number and a bitmap.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the A-MPDU component 724. Further, each of the components illustrated in FIG. 7 may be implemented using a plurality of separate elements.

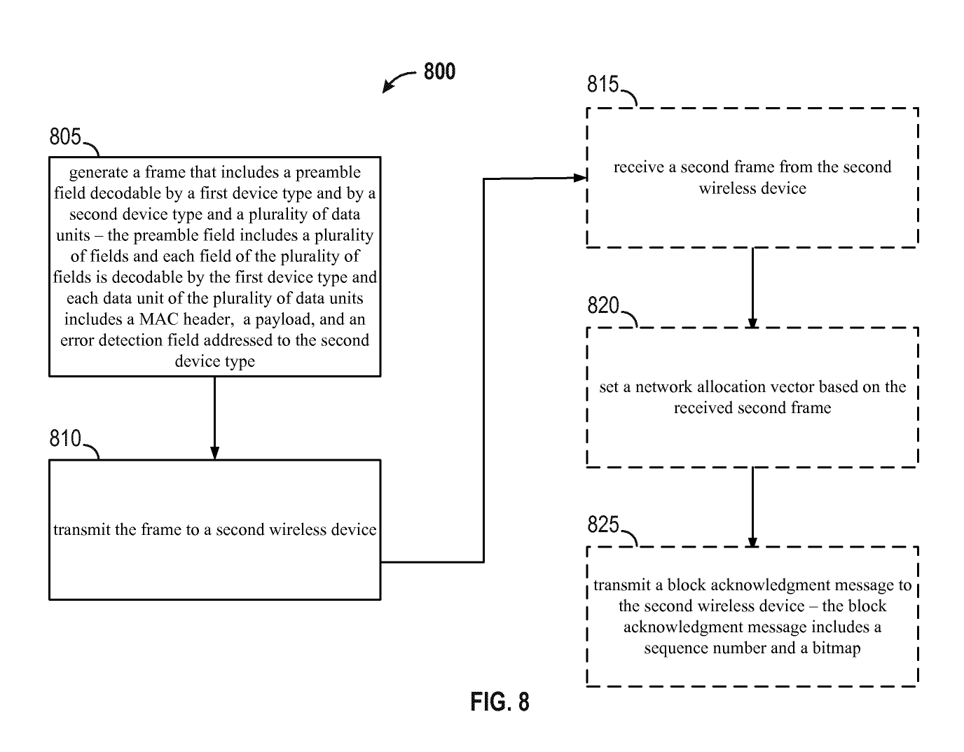

FIG. 8 is a flowchart of an exemplary method 800 of wireless communication using a modified frame type. The method 800 may be performed using an apparatus (e.g., the AP 104, the AP 202, the STA 114, the STA 208, or the wireless device 702, for example). Although the method 800 is described below with respect to the elements of wireless device 702 of FIG. 7, other components may be used to implement one or more of the steps described herein. In FIG. 8, blocks denoted with dotted lines indicated optional operations.

At block 805, the apparatus may generate a frame that may include a preamble decodable by a first device type and by a second device type and a plurality of data units. The apparatus may generate the preamble, which may include a number of fields, and each field of the plurality of fields may be decodable by the first device type. The apparatus may generate the plurality of data units, and each data unit of the plurality of data units may include a payload and an error detection field addressed to the second device type. The apparatus may combine the preamble with the plurality of data units to generate the frame.

At block 810, the apparatus may transmit the frame to a second wireless device.

At block 815, the apparatus may receive a second frame from the second wireless device.

At block 820, the apparatus may set a network allocation vector based on the received second frame.

At block 825, the apparatus may transmit a block acknowledgment message to the second wireless device. The block acknowledgment message may include a sequence number and a bitmap.

In one example, the AP 202 may generate the frame 310 that includes the legacy preamble 320 decodable by the STA 206 (e.g., a legacy STA compliant with IEEE 802.11a/g) and by the STA 208 (e.g., a non-legacy STA compliant with IEEE 802.11ac/n or a future standard). The frame 310 may include a plurality of MPDUs 334. Each MPDU 334 in the plurality of MPDUs 334 may include a payload and an FCS field addressed to or decodable by the STA 208. In one configuration, each MPDU 334 of the plurality of MPDUs 334 is aggregated into an A-MPDU 330. In this configuration, the frame 310 may include an A-MPDU container header 324 and an FCS 340. The A-MPDU container header 324 includes information associated with the A-MPDU 330 (e.g., the presence and/or type of A-MPDU), and the FCS 340 may be based on the A-MPDU 330. In one configuration, the information in the A-MPDU container header 324 may include a receive address, transmit address, and a duration value/field associated with each MPDU 334, and each MPDU 334 may not contain the receive address, transmit address, and duration value/field. In one configuration, each MPDU 334 includes a length field that indicates a data length of the payload within the MPDU 334. In another configuration, each MPDU 334 includes an MPDU delimiter. The AP 202 may transmit the frame 310 to the STAs 208 and other STAs.

In another example, the AP 202 may generate the frame 410 that includes the legacy preamble 420 decodable by the STA 206 (e.g., a legacy STA compliant with IEEE 802.11a/g) and by the STA 208 (e.g., a non-legacy STA compliant with future IEEE 802.11 standards). The frame 410 may include a plurality of MPDUs (e.g., the first MPDU 430 and the MPDUs in the A-MPDU 460). The plurality of MPDUs includes the first MPDU 430 and a subset of MPDUs aggregated into the A-MPDU 460. The first MPDU 430 is unaggregated. In one configuration, each MPDU in the A-MPDU 330 is preceded by an MPDU delimiter. A last MPDU in the A-MPDU 460 may include an FCS field computed based on the first MPDU 430 and the A-MPDU 460. In one configuration, the first MPDU 430 may include a duration field and a length field, and the length field indicates a data length of the payload in the first MPDU 430. The AP 202 may transmit the frame 410 to the STAs 208 and other STAs.

In another example, the AP 202 may generate the frame 510 that includes the legacy preamble 520 decodable by the STA 206 (e.g., a legacy STA compliant with IEEE 802.11a/g) and by the STA 208 (e.g., a non-legacy STA compliant with future IEEE 802.11 standards). The frame 510 may include a plurality of MPDUs (e.g., the first MPDU 530, the second MPDU 532, and the third MPDU 534). Each MPDU may include a payload and a FCS, both of which may be addressed to and decodable by the STA 206. In one configuration, each MPDU includes a header field that includes a length field that indicates a data length of the payload, and each MPDU is not preceded by a delimiter field. In another configuration, each MPDU includes a header field that includes a delimiter field positioned after all the other fields in the header field but before the payload. The AP 202 may transmit the frame 410 to the STAs 208 and other STAs.

In another example, the AP 202 may generate the frame 610 that includes the legacy preamble 620 decodable by the STA 206 (e.g., a legacy STA compliant with IEEE 802.11a/g) and by the STA 208 (e.g., a non-legacy STA compliant with future IEEE 802.11 standards). The frame 610 may include a plurality of MPDUs aggregated into the A-MPDU 630. In one configuration, the legacy preamble 620 may include information indicating that the A-MPDU 630 is present. The information may be located in the signal field of the legacy preamble 620. In another configuration, the information may be in the service field of the frame 610. The AP 202 may transmit the frame 610 to the STAs 208 and other STAs.

Although the above examples have been discussed from the point of view of the AP 202 transmitting a frame to the STA 208, the method/procedure also applies when the STA 208 (or another STA) transmits a frame to an AP. For example, the STA 208 may generate the frame 310 which may include the legacy preamble 320 decodable by a first AP compliant with the IEEE 802.11a/g standards and by a second AP compliant with future IEEE 802.11 standards. Each MPDU 334 of the plurality of MPDUs 334 may include a payload and an FCS addressed to/decodable by the second AP. The STA 208 may transmit the frame 310 to the second AP.

In another example, the STAs 206, 208 may receive a frame from the AP 202. If the frame was not intended for the STA 206, the STA 206 may set a NAV based on the received frame. If the frame was intended for the STA 208, and the STA 208 successfully receives and decodes the frame, the STA 208 may transmit a block acknowledgment message to the AP 202. The block acknowledgment message may include a sequence number and a bitmap.

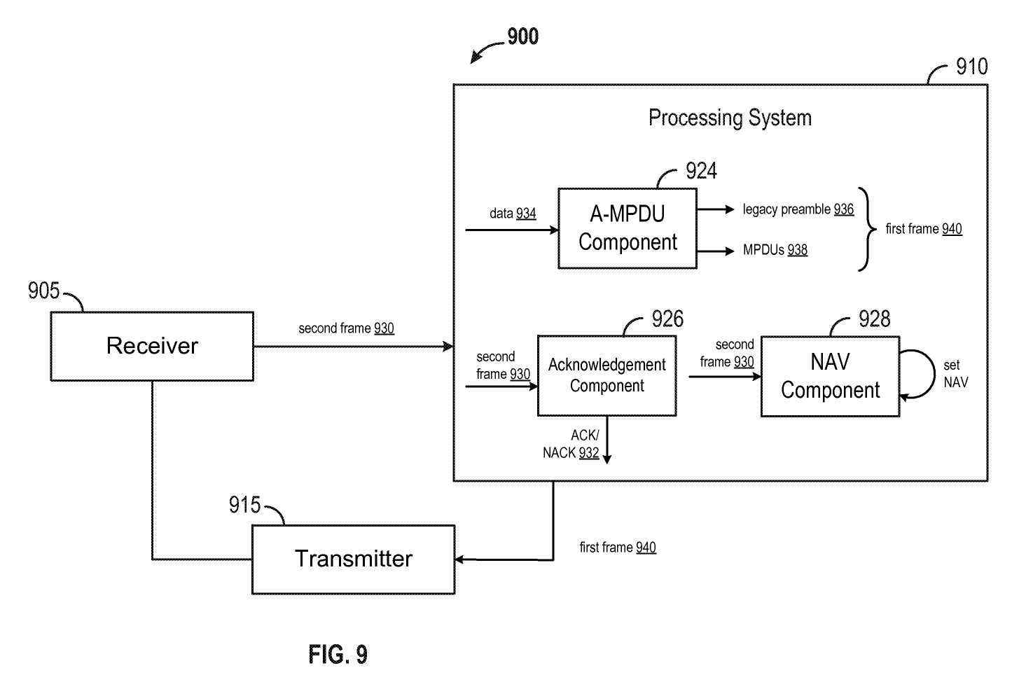

FIG. 9 is a functional block diagram of an exemplary wireless communication device 900 using a modified frame type. The wireless communication device 900 may include a receiver 905, a processing system 910, and a transmitter 915. The processing system 910 may include an A-MPDU component 924, an acknowledgment component 926, and/or a NAV component 928. The processing system 910 and/or the A-MPDU component 924 may be configured to generate a frame (a first frame 940) that includes a preamble (e.g., a legacy preamble 936) decodable by a first device type and by a second device type and a plurality of data units (e.g. MPDUs 938). The frame may be generated based on data 934 to be transmitted by the wireless communication device 900. The preamble may include a number of fields, and each field of the plurality of fields may be decodable by the first device type. Each data unit of the plurality of data units may include a payload and an error detection field addressed to the second device type. The processing system 910, the A-MPDU component 924, and/or the transmitter 915 may be configured to transmit the frame to a second wireless device. In one configuration, each data unit of the plurality of data units may be aggregated into an aggregated data unit. The frame may include a container header field and a container error detection field, and the container header field may include information associated with the aggregated data unit, and the container error detection field may be based on the aggregated data unit. In another configuration, the information in the container header field may include a receive address, a transmit address, and a duration value associated with each data unit of the plurality of data units, and each data unit of the plurality of data units may not include the receive address, the transmit address, and the duration value. In another configuration, each data unit of the plurality of data units may include a length field, and the length field may indicate a data length of the payload. In another configuration, each data unit of the plurality of data units may include a delimiter field. In another configuration, the plurality of data units may include an unaggregated data unit and a subset of data units, and each data unit in the subset of data units may be preceded by a delimiter field and each data unit in the subset of data units may be aggregated into an aggregated data unit that includes a plurality of delimiter fields, and the error detection field of a last data unit in the aggregated data unit may be computed based on the plurality of data units. In another configuration, the unaggregated data unit may include a duration field and a length field. The length field may indicate a data length of the payload in the unaggregated data unit. In another configuration, each data unit of the plurality of data units may include a header field that includes a length field indicating a data length of the payload, and each data unit of the plurality of data units may not be preceded by a delimiter field. In another configuration, each data unit of the plurality of data units may include a header field that includes a second plurality of fields and a delimiter field, and the second plurality of fields may precede the delimiter field, and the delimiter field may precede the payload. In another configuration, each data unit of the plurality of data units may be aggregated into an aggregated data unit. In an aspect, the frame may include information associated with the aggregated data unit in at least one of a signal field included within the preamble or a service field. In another configuration, the processing system 910, the A-MPDU component 924, and/or the receiver 905 may be configured to receive a second frame (e.g., a second frame 930) from the second wireless device. In one aspect, the processing system 910, the A-MPDU component 924, and/or the NAV component 928 may be configured to set a NAV based on the received second frame. In another aspect, the processing system 910, the A-MPDU component 924, the acknowledgment component 926, and/or the transmitter 915 may be configured to transmit a block acknowledgment message (e.g., an ACK/NACK message 932) to the second wireless device, in which the block acknowledgment message includes a sequence number and a bitmap. The block acknowledgment message may be based on the received second frame.

The receiver 905, the processing system 910, the A-MPDU component 924, and/or the transmitter 915 may be configured to perform one or more functions discussed above with respect to blocks 805, 810, 815, and 820 of FIG. 8. The receiver 905 may correspond to the receiver 712. The processing system 910 may correspond to the processor 704. The transmitter 915 may correspond to the transmitter 710. The A-MPDU component 924 may correspond to the A-MPDU components 124, 126 and/or the A-MPDU component 724.

In one configuration, the wireless communication device 900 may include means for generating a frame comprising a preamble decodable by a first device type and by a second device type and a plurality of data units. The preamble may include a plurality of fields and each field of the plurality of fields may be decodable by the first device type. Each data unit of the plurality of data units may include a payload and an error detection field addressed to the second device type. The wireless communication device 900 may include means for transmitting the frame to a second wireless device. In another aspect, each data unit of the plurality of data units may be aggregated into an aggregated data unit, and the frame may further include a container header field and a container error detection field, in which the container header field includes information associated with the aggregated data unit, and the container error detection field is based on the aggregated data unit. In another aspect, the information in the container header field may include a receive address, a transmit address, and a duration value associated with each data unit of the plurality of data units, and each data unit of the plurality of data units may not include the receive address, the transmit address, and the duration value. In another aspect, each data unit of the plurality of data units further may include a length field, the length field indicating a data length of the payload. In another aspect, each data unit of the plurality of data units may further include a delimiter field. In another aspect, the plurality of data units may include an unaggregated data unit and a subset of data units, in which each data unit in the subset of data units may be preceded by a delimiter field and each data unit in the subset of data units may be aggregated into an aggregated data unit that includes a plurality of delimiter fields. In this aspect, the error detection field of a last data unit in the aggregated data unit may be based on the plurality of data units. In another aspect, the unaggregated data unit may include a duration field and a length field, and the length field may indicate a data length of the payload in the unaggregated data unit. In another aspect, each data unit of the plurality of data units may further include a header field that includes a length field indicating a data length of the payload, and each data unit of the plurality of data units may not be preceded by a delimiter field. In another aspect, each data unit of the plurality of data units may further include a header field that includes a second plurality of fields and a delimiter field, and the second plurality of fields may precede the delimiter field, and the delimiter field may precede the payload. In another aspect, each data unit of the plurality of data units may be aggregated into an aggregated data unit. In another aspect, the frame may include information associated with the aggregated data unit in at least one of a signal field included within the preamble or a service field. In another configuration, the wireless communication device 900 may include means for receiving a second frame from the second wireless device and means for setting a network allocation vector based on the received second frame. In another configuration, the wireless communication device 900 may include means for receiving a second frame from the second wireless device and means for transmitting a block acknowledgment message to the second wireless device, wherein the block acknowledgment message includes a sequence number and a bitmap.

For example, means for generating a frame may comprise the processing system 910 and/or the A-MPDU component 924. The processing system 910 and/or the A-MPDU component 924 may generate a frame by determining information to be included in the various fields (e.g., STF, LTF, SIG). The processing system 910 and/or the A-MPDU component 924 may encode the information onto symbols which respect to each field. The processing system 910 and/or the A-MPDU component 924 may combine the encoded information into a frame. Means for transmitting the frame to a second wireless device may comprise the processing system 910, the A-MPDU component 924, and/or the transmitter 915. Means for receiving a second frame from the second wireless device may comprise the processing system 910, the A-MPDU component 924, and/or the receiver 905. Means for setting a network allocation vector may comprise the processing system 910, the NAV component 928, and/or the A-MPDU component 924. Means for transmitting a block acknowledgment message may comprise the processing system 910, the A-MPDU component 924, the acknowledgment component 926, and/or the transmitter 915.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims. The various figures may depict elements with dotted lines. In some instances, elements depicted with dotted lines may be considered optional features.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication for a first wireless device, comprising:
generating a frame comprising a preamble decodable by a first device type and by a second device type and a plurality of data units, wherein the preamble comprises a plurality of fields and each field of the plurality of fields is decodable by the first device type and the second device type, wherein the first device type is compatible with at least one of an IEEE 802.11a, an IEEE 802.11b, or an IEEE 802.11g standard, and wherein each data unit of the plurality of data units comprises a medium access control (MAC) header, a payload, and an error detection field decodable by the second device type that is different from the first device type; and
transmitting the frame to a second wireless device, wherein the frame indicates a presence of the plurality of data units outside of the preamble.

2. The method of claim 1, wherein each data unit of the plurality of data units is aggregated into an aggregated data unit, wherein the frame further comprises a container header field and a container error detection field, wherein the container header field includes information associated with the aggregated data unit, and the container error detection field is based on the aggregated data unit.

3. The method of claim 2, wherein the information in the container header field includes a receive address, a transmit address, and a duration value associated with each data unit of the plurality of data units, and wherein each data unit of the plurality of data units does not include the receive address, the transmit address, and the duration value.

4. The method of claim 3, wherein each data unit of the plurality of data units further comprises a length field, the length field indicating a data length of the payload.

5. The method of claim 3, wherein each data unit of the plurality of data units further comprises a delimiter field.

6. The method of claim 1, wherein the plurality of data units comprises an unaggregated data unit and a subset of data units, wherein each data unit in the subset of data units is preceded by a delimiter field and each data unit in the subset of data units is aggregated into an aggregated data unit that includes a plurality of delimiter fields, and wherein the error detection field of a last data unit in the aggregated data unit is based on the plurality of data units.

7. The method of claim 6, wherein the unaggregated data unit comprises a duration field and a length field, the length field indicating a data length of the payload in the unaggregated data unit.

8. The method of claim 1, wherein each data unit of the plurality of data units further comprises a header field that includes a length field indicating a data length of the payload, and wherein each data unit of the plurality of data units is not preceded by a delimiter field.

9. The method of claim 1, wherein each data unit of the plurality of data units further comprises a header field that includes a second plurality of fields and a delimiter field, wherein the second plurality of fields precedes the delimiter field, and the delimiter field precedes the payload.

10. The method of claim 1, wherein each data unit of the plurality of data units is aggregated into an aggregated data unit.

11. The method of claim 10, wherein the frame includes information associated with the aggregated data unit in at least one of a signal field included within the preamble or a service field.

12. The method of claim 1, further comprising:
receiving a second frame from the second wireless device; and
setting a network allocation vector based on the received second frame.

13. The method of claim 1, further comprising:
receiving a second frame from the second wireless device; and
transmitting a block acknowledgment message to the second wireless device, wherein the block acknowledgment message includes a sequence number and a bitmap.

14. The method of claim 1, wherein the second device type is compatible with an IEEE standard subsequent to the IEEE 802.11a, the IEEE 802.11b, and the IEEE 802.11g standards, and the preamble is compatible with at least one of the IEEE 802.11a, the IEEE 802.11b, or the IEEE 802.11g standard and is associated with but does not indicate a presence of an aggregated data unit.

15. An apparatus for wireless communication, comprising:
means for generating a frame comprising a preamble decodable by a first device type and by a second device type and a plurality of data units, wherein the preamble comprises a plurality of fields and each field of the plurality of fields is decodable by the first device type and the second device type, wherein the first device type is compatible with at least one of an IEEE 802.11a, an IEEE 802.11b, or an IEEE 802.11g standard, and wherein each data unit of the plurality of data units comprises a medium access control (MAC) header, a payload, and an error detection field decodable by the second device type that is different from the first device type; and
means for transmitting the frame to a wireless device, wherein the frame indicates a presence of the plurality of data units outside of the preamble.

16. The apparatus of claim 15, further comprising:
receiving a second frame from the wireless device; and
setting a network allocation vector based on the received second frame.

17. An apparatus for wireless communication, comprising:
a memory; and
at least one processor coupled to the memory and configured to:
generate a frame comprising a preamble decodable by a first device type and by a second device type and a plurality of data units, wherein the preamble comprises a plurality of fields and each field of the plurality of fields is decodable by the first device type and the second device type, wherein the first device type is compatible with at least one of an IEEE 802.11a, an IEEE 802.11b, or an IEEE 802.11g standard, and wherein each data unit of the plurality of data units comprises a medium access control (MAC) header, a payload, and an error detection field decodable by the second device type that is different from the first device type; and
transmit the frame to a wireless device, wherein the frame indicates a presence of the plurality of data units outside of the preamble.

18. The apparatus of claim 17, wherein each data unit of the plurality of data units is aggregated into an aggregated data unit, wherein the frame further comprises a container header field and a container error detection field, wherein the container header field includes information associated with the aggregated data unit, and the container error detection field is based on the aggregated data unit.

19. The apparatus of claim 18, wherein the information in the container header field includes a receive address, a transmit address, and a duration value associated with each data unit of the plurality of data units, and wherein each data unit of the plurality of data units does not include the receive address, the transmit address, and the duration value.

20. The apparatus of claim 19, wherein each data unit of the plurality of data units further comprises a length field, the length field indicating a data length of the payload.

21. The apparatus of claim 19, wherein each data unit of the plurality of data units further comprises a delimiter field.

22. The apparatus of claim 17, wherein the plurality of data units comprises an unaggregated data unit and a subset of data units, wherein each data unit in the subset of data units is preceded by a delimiter field and each data unit in the subset of data units is aggregated into an aggregated data unit that includes a plurality of delimiter fields, and wherein the error detection field of a last data unit in the aggregated data unit is based on the plurality of data units.

23. The apparatus of claim 22, wherein the unaggregated data unit comprises a duration field and a length field, the length field indicating a data length of the payload in the unaggregated data unit.

24. The apparatus of claim 17, wherein each data unit of the plurality of data units further comprises a header field that includes a length field indicating a data length of the payload, and wherein each data unit of the plurality of data units is not preceded by a delimiter field.

25. The apparatus of claim 17, wherein each data unit of the plurality of data units further comprises a header field that includes a second plurality of fields and a delimiter field, wherein the second plurality of fields precedes the delimiter field, and the delimiter field precedes the payload.

26. The apparatus of claim 17, wherein each data unit of the plurality of data units is aggregated into an aggregated data unit.

27. The apparatus of claim 26, wherein the frame includes information associated with the aggregated data unit in at least one of a signal field included within the preamble or a service field.

28. The apparatus of claim 17, wherein the at least one processor is further configured to:
receive a second frame from the wireless device; and
set a network allocation vector based on the received second frame.

29. The apparatus of claim 17, wherein the at least one processor is further configured to:
receive a second frame from the wireless device; and
transmit a block acknowledgment message to the wireless device, wherein the block acknowledgment message includes a sequence number and a bitmap.

30. A computer-readable medium storing computer executable code for wireless communication, comprising code for:
generating a frame comprising a preamble decodable by a first device type and by a second device type and a plurality of data units, wherein the preamble comprises a plurality of fields and each field of the plurality of fields is decodable by the first device type and the second device type, wherein the first device type is compatible with at least one of an IEEE 802.11a, an IEEE 802.11b, or an IEEE 802.11g standard, and wherein each data unit of the plurality of data units comprises a medium access control (MAC) header, a payload, and an error detection field decodable by the second device type that is different from the first device type; and
transmitting the frame to a wireless device, wherein the frame indicates a presence of the plurality of data units outside of the preamble.
